(19) United States
(12) Patent Application Publication
(10) Pub. No.: US 2024/0364843 A1
(43) Pub. Date: Oct. 31, 2024

(54) METHOD, APPARATUS, AND MEDIUM FOR VIDEO PROCESSING

(71) Applicant: Bytedance Inc., Los Angeles, CA (US)

(72) Inventor: Ye-Kui WANG, Los Angeles, CA (US)

(21) Appl. No.: 18/769,164

(22) Filed: Jul. 10, 2024

Related U.S. Application Data
(63) Continuation of application No. PCT/US2023/060470, filed on Jan. 11, 2023.
(60) Provisional application No. 63/298,461, filed on Jan. 11, 2022.

(51) Int. Cl. H04N 7/01; H04N 19/132; H04N 19/172; H04N 19/70

(52) U.S. Cl. CPC H04N 7/01; H04N 19/132; H04N 19/172; H04N 19/70

(57) ABSTRACT

Embodiments of the present disclosure provide a solution for video processing. A method for video processing is proposed. The method comprises: performing a conversion between a bitstream of a video and a media file of the video, wherein the media file comprises an external stream track comprising a set of samples, a sample entry type of a sample entry for the set of samples is encapsulated based on a restricted scheme, the sample entry comprises an indication associated with the restricted scheme, and a value of the indication indicates that a sample in the set of samples is allowed to contain more than one coded picture of the external stream track.

### CROSS REFERENCE TO RELATED APPLICATIONS

This application is a continuation of International Application No. PCT/US2023/060470, filed on Jan. 11, 2023, which claims the benefit of U.S. Provisional Application Ser. No. 63/298,461, and filed on Jan. 11, 2022. The entire contents of these applications are hereby incorporated by reference in their entireties.

### FIELD

Embodiments of the present disclosure relates generally to video processing techniques, and more particularly, to signaling of an external stream track in a media file.

### BACKGROUND

Media streaming applications are typically based on the internet protocol (IP), transmission control protocol (TCP), and hypertext transfer protocol (HTTP) transport methods, and typically rely on a file format such as the ISO base media file format (ISOBMFF). One such streaming system is dynamic adaptive streaming over HTTP (DASH). In DASH, there may be multiple representations for video and/or audio data of multimedia content, different representations may correspond to different coding characteristics (e.g., different profiles or levels of a video coding standard, different bitrates, different spatial resolutions, etc.). Moreover, extended dependent random access point (EDRAP) pictures based video coding and streaming are proposed. Therefore, it is worth studying on signaling of external stream tracks.

### SUMMARY

Embodiments of the present disclosure provide a solution for video processing.

In a first aspect, a method for video processing is proposed. The method comprises: performing a conversion between a bitstream of a video and a media file of the video, wherein the media file comprises an external stream track comprising a set of samples, a sample entry type of a sample entry for the set of samples is encapsulated based on a restricted scheme, the sample entry comprises an indication associated with the restricted scheme, and a value of the indication indicates that a sample in the set of samples is allowed to contain more than one coded picture of the external stream track.

According to the method in accordance with the first aspect of the present disclosure, a new restricted scheme is employed to indicate that a sample in an external stream track is allowed to contain more than one coded picture. Compared with the conventional solution, the proposed method can advantageously support the EDRAP-based technology more efficiently.

In a second aspect, an apparatus for processing video data is proposed. The apparatus for processing video data comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by a video processing apparatus. The method comprises: performing a conversion between the bitstream and a media file of the video, wherein the media file comprises an external stream track comprising a set of samples, a sample entry type of a sample entry for the set of samples is encapsulated based on a restricted scheme, the sample entry comprises an indication associated with the restricted scheme, and a value of the indication indicates that a sample in the set of samples is allowed to contain more than one coded picture of the external stream track.

In a fifth aspect, a method for storing a bitstream of a video is proposed. The method comprises: performing a conversion between the bitstream and a media file of the video; and storing the bitstream in a non-transitory computer-readable recording medium, wherein the media file comprises an external stream track comprising a set of samples, a sample entry type of a sample entry for the set of samples is encapsulated based on a restricted scheme, the sample entry comprises an indication associated with the restricted scheme, and a value of the indication indicates that a sample in the set of samples is allowed to contain more than one coded picture of the external stream track.

In a sixth method, another non-transitory computer-readable recording medium is proposed. The non-transitory computer-readable recording medium stores a media file of a video which is generated by a method performed by a video processing apparatus. The method comprises: performing a conversion between a bitstream of the video and the media file, wherein the media file comprises an external stream track comprising a set of samples, a sample entry type of a sample entry for the set of samples is encapsulated based on a restricted scheme, the sample entry comprises an indication associated with the restricted scheme, and a value of the indication indicates that a sample in the set of samples is allowed to contain more than one coded picture of the external stream track.

In a seventh aspect, a method for storing a media file of a video is proposed. The method comprises: performing a conversion between a bitstream of the video and the media file; and storing the media file in a non-transitory computer-readable recording medium, wherein the media file comprises an external stream track comprising a set of samples, a sample entry type of a sample entry for the set of samples is encapsulated based on a restricted scheme, the sample entry comprises an indication associated with the restricted scheme, and a value of the indication indicates that a sample in the set of samples is allowed to contain more than one coded picture of the external stream track.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram of an example video coding system in accordance with some embodiments of the present disclosure;

FIG. 2 illustrates a block diagram of an example video encoder in accordance with some embodiments of the present disclosure;

FIG. 3 illustrates a block diagram of an example video decoder in accordance with some embodiments of the present disclosure;

FIG. 4 is a diagram for illustrating the concept of random access points (RAPs);

FIG. 5 is another diagram for illustrating the concept of RAPs;

FIG. 6 is a diagram for illustrating the concept of dependent random access points (DRAPs);

FIG. 7 is another diagram for illustrating the concept of DRAPS;

FIG. 8 is a diagram for illustrating the concept of extended dependent random access points (EDRAPs);

FIG. 9 is another diagram for illustrating the concept of EDRAPs;

FIG. 10 is a diagram for illustrating EDRAP based video streaming;

FIG. 11 is another diagram for illustrating EDRAP based video streaming;

FIG. 12 illustrates a flowchart of a method for video processing in accordance with some embodiments of the present disclosure; and

FIG. 13 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

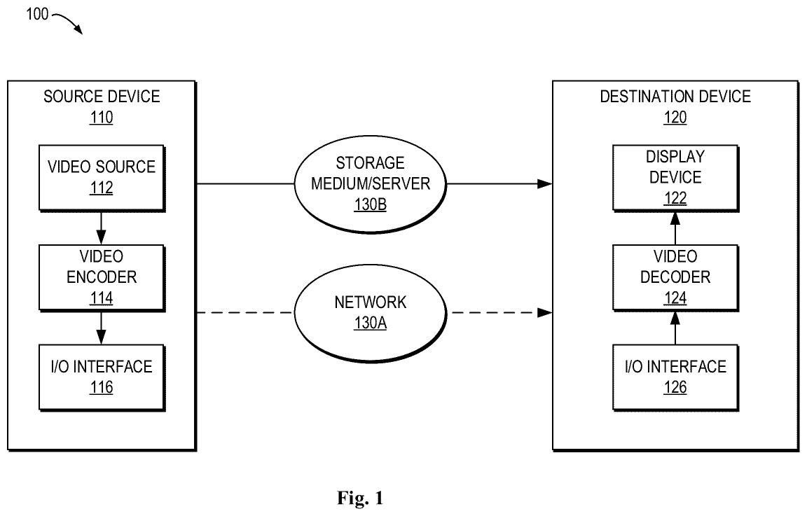

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

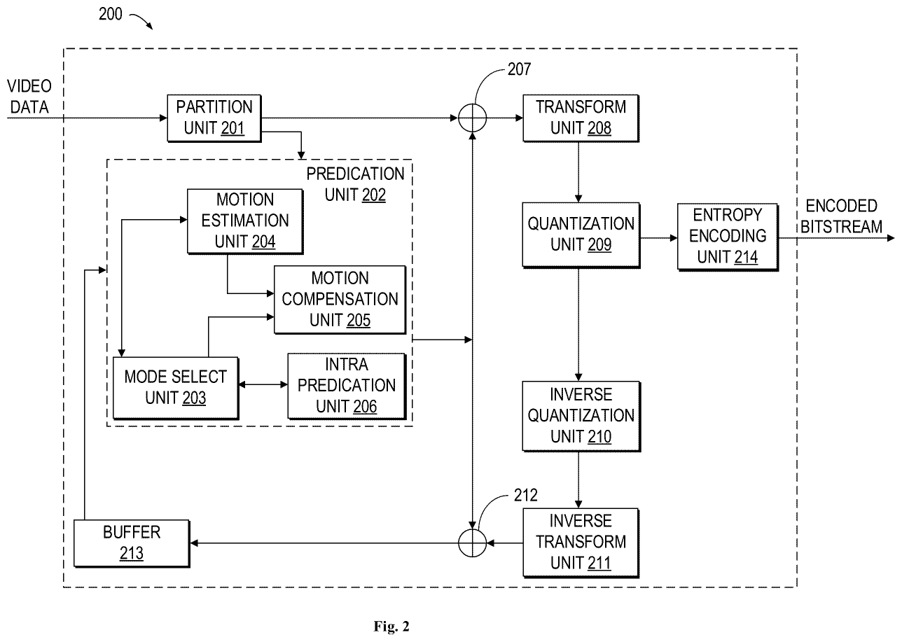

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

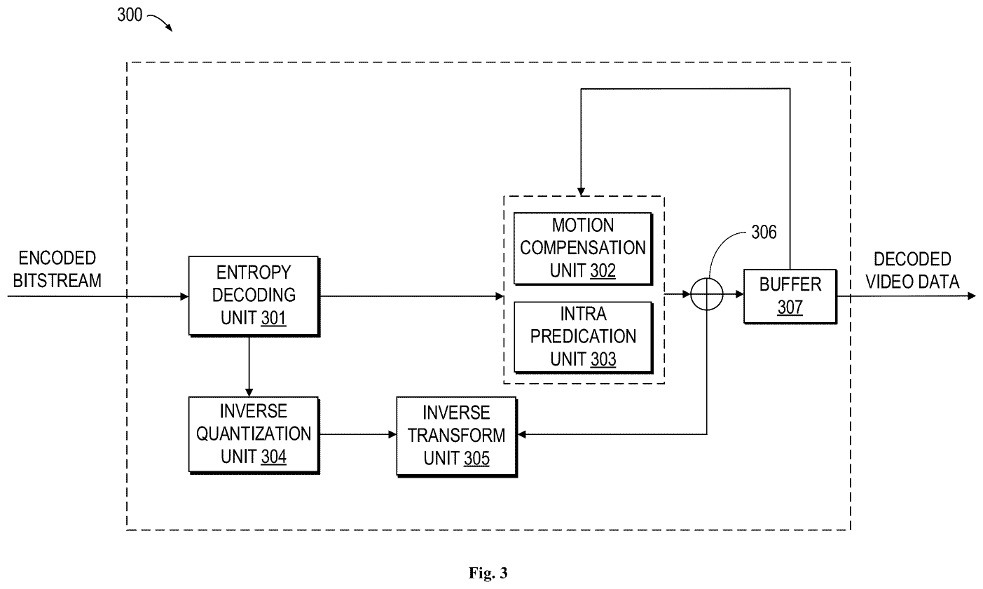

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Summary

This disclosure is related to media file formats. Specifically, it is related to signalling of external stream tracks (ESTs) with an appropriate sample entry type such that it is allowed to have more than one coded picture in one sample in an EST. An EST provides external pictures needed for random accessing from an extended dependent random access point (EDRAP) picture in a main stream track (MST). The ideas may be applied individually or in various combination, to media files according to any media file formats, e.g., the ISO base media file format (ISOBMFF) and file format derived from the ISOBMFF.

### 2. Background

### 2.1 Video Coding Standards

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. Since then, many new methods have been adopted by JVET and put into the reference software named Joint Exploration Model (JEM). The JVET was later renamed to be the Joint Video Experts Team (JVET) when the Versatile Video Coding (VVC) project officially started. VVC is the new coding standard, targeting at 50% bitrate reduction as compared to HEVC, that has been finalized by the JVET at its 19th meeting ended at Jul. 1, 2020.

The Versatile Video Coding (VVC) standard (ITU-T H.266|ISO/IEC 23090-3) and the associated Versatile Supplemental Enhancement Information (VSEI) standard (ITU-T H.274|ISO/IEC 23002-7) have been designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 360° immersive media.

### 2.2 File Format Standards

Media streaming applications are typically based on the IP, TCP, and HTTP transport methods, and typically rely on a file format such as the ISO base media file format (ISOBMFF). One such streaming system is dynamic adaptive streaming over HTTP (DASH). For using a video format with ISOBMFF and DASH, a file format specification specific to the video format, such as the AVC file format and the HEVC file format, would be needed for encapsulation of the video content in ISOBMFF tracks and in DASH representations and segments. Important information about the video bitstreams, e.g., the profile, tier, and level, and many others, would need to be exposed as file format level metadata and/or DASH media presentation description (MPD) for content selection purposes, e.g., for selection of appropriate media segments both for initialization at the beginning of a streaming session and for stream adaptation during the streaming session. Similarly, for using an image format with ISOBMFF, a file format specification specific to the image format, such as the AVC image file format and the HEVC image file format, would be needed.

### 2.3 Random Access and its Supports in HEVC and VVC

Random access refers to starting access and decoding of a bitstream from a picture that is not the first picture of the bitstream in decoding order. To support tuning in and channel switching in broadcast/multicast and multiparty video conferencing, seeking in local playback and streaming, as well as stream adaptation in streaming, the bitstream needs to include frequent random access points, which are typically intra coded pictures but may also be inter-coded pictures (e.g., in the case of gradual decoding refresh).

HEVC includes signaling of intra random access points (IRAP) pictures in the NAL unit header, through NAL unit types. Three types of IRAP pictures are supported, namely instantaneous decoder refresh (IDR), clean random access (CRA), and broken link access (BLA) pictures. IDR pictures are constraining the inter-picture prediction structure to not reference any picture before the current group-of-pictures (GOP), conventionally referred to as closed-GOP random access points. CRA pictures are less restrictive by allowing certain pictures to reference pictures before the current GOP, all of which are discarded in case of a random access. CRA pictures are conventionally referred to as open-GOP random access points. BLA pictures usually originate from splicing of two bitstreams or part thereof at a CRA picture, e.g., during stream switching. To enable better systems usage of IRAP pictures, altogether six different NAL units are defined to signal the properties of the IRAP pictures, which can be used to better match the stream access point types as defined in the ISO base media file format (ISOBMFF), which are utilized for random access support in dynamic adaptive streaming over HTTP (DASH).

VVC supports three types of IRAP pictures, two types of IDR pictures (one type with or the other type without associated RADL pictures) and one type of CRA picture. These are basically the same as in HEVC. The BLA picture types in HEVC are not included in VVC, mainly due to two reasons: i) The basic functionality of BLA pictures can be realized by CRA pictures plus the end of sequence NAL unit, the presence of which indicates that the subsequent picture starts a new CVS in a single-layer bitstream. ii) There was a desire in specifying less NAL unit types than HEVC during the development of VVC, as indicated by the use of five instead of six bits for the NAL unit type field in the NAL unit header.

Another key difference in random access support between VVC and HEVC is the support of GDR in a more normative manner in VVC. In GDR, the decoding of a bitstream can start from an inter-coded picture and although at the beginning not the entire picture region can be correctly decoded but after a number of pictures the entire picture region would be correct. AVC and HEVC also support GDR, using the recovery point SEI message for signaling of GDR random access points and the recovery points. In VVC, a new NAL unit type is specified for indication of GDR pictures and the recovery point is signaled in the picture header syntax structure. A CVS and a bitstream are allowed to start with a GDR picture. This means that it is allowed for an entire bitstream to contain only inter-coded pictures without a single intra-coded picture. The main benefit of specifying GDR support this way is to provide a conforming behavior for GDR. GDR enables encoders to smooth the bit rate of a bitstream by distributing intra-coded slices or blocks in multiple pictures as opposed intra coding entire pictures, thus allowing significant end-to-end delay reduction, which is considered more important nowadays than before as ultralow delay applications like wireless display, online gaming, drone based applications become more popular.

Another GDR related feature in VVC is the virtual boundary signaling. The boundary between the refreshed region (i.e., the correctly decoded region) and the unrefreshed region at a picture between a GDR picture and its recovery point can be signaled as a virtual boundary, and when signaled, in-loop filtering across the boundary would not be applied, thus a decoding mismatch for some samples at or near the boundary would not occur. This can be useful when the application determines to display the correctly decoded regions during the GDR process.

IRAP pictures and GDR pictures can be collectively referred to as random access point (RAP) pictures.

### 2.4 Extended Dependent Random Access Point (EDRAP) Based Video Coding, Storage and Streaming

### 2.4.1 the Concept and the Standard Supports

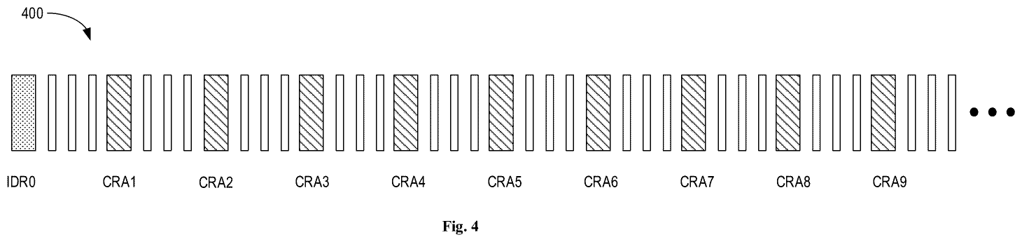

The concept of EDRAP based video coding, storage and streaming is described with reference to FIGS. 4-11 as below.

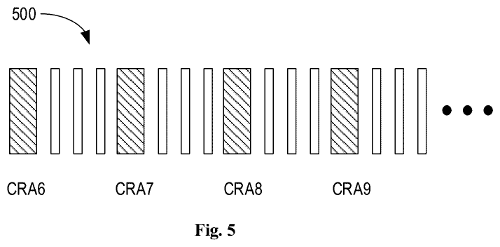

FIGS. 4 and 5 are diagrams that illustrate the existing concept of random access points (RAPs). The application (e.g., adaptive streaming) determines the frequency of random access points (RAPs), e.g., RAP period 1 s or 2 s. Conventionally RAPs are provided by coding of IRAP pictures, as shown in FIG. 4. Note that inter prediction references for the non-key pictures between RAP pictures are not shown, and from left to right is the output order. When random accessing from CRA6, the decoder receives and correctly decodes the pictures as shown in FIG. 5.

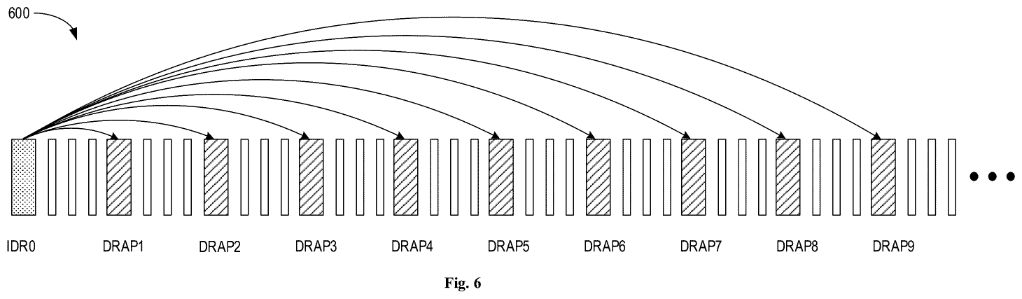

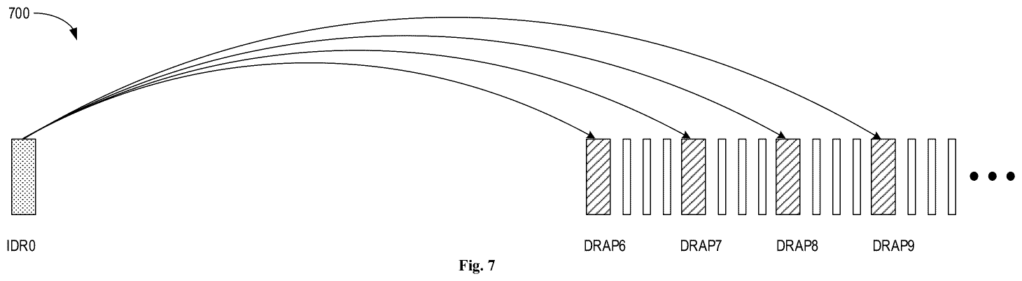

FIGS. 6 and 7 are diagrams that illustrate the concept of dependent random access points (DRAPs). The DRAP approach provides improved coding efficiency by allowing a DRAP picture (and subsequent pictures) to refer to the previous IRAP picture for inter prediction, as shown in FIG. 6. Note that inter prediction for the non-key pictures between RAP pictures are not shown, and from left to right is the output order. When random accessing from DRAP6, the decoder receives and correctly decodes the pictures as shown in FIG. 7.

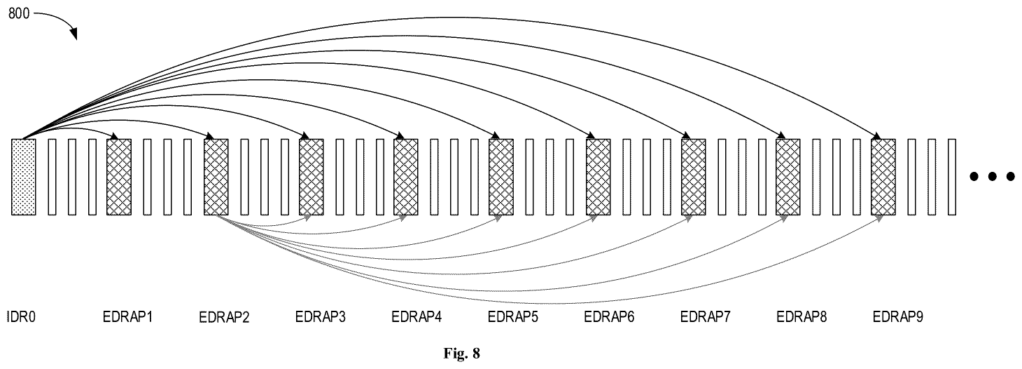

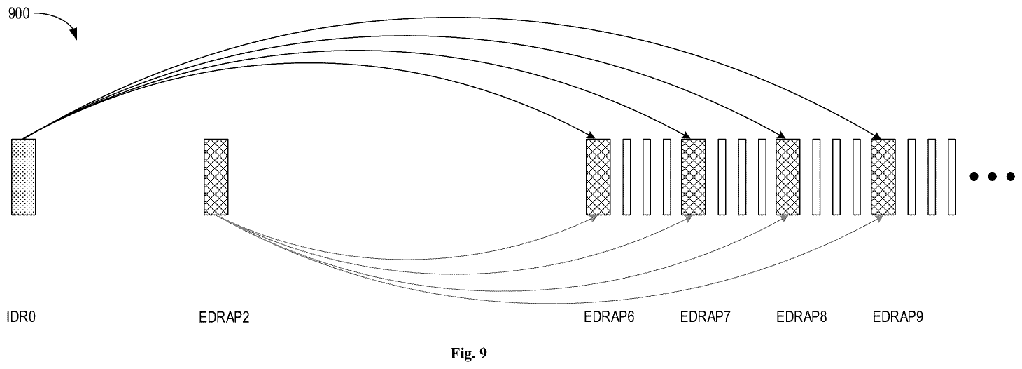

FIGS. 8 and 9 are diagrams that illustrate the concept of extended dependent random access points (EDRAPs). The EDRAP approach provides a bit more flexibility by allowing an EDRAP picture (and subsequent pictures) to refer to a few of the earlier RAP pictures (IRAP or EDRAP), e.g., as shown in FIG. 8. Note that inter prediction for the non-key pictures between RAP pictures are not shown, and from left to right is the output order. When random accessing from EDRAP6, the decoder receives and correctly decodes the pictures as shown in FIG. 9.

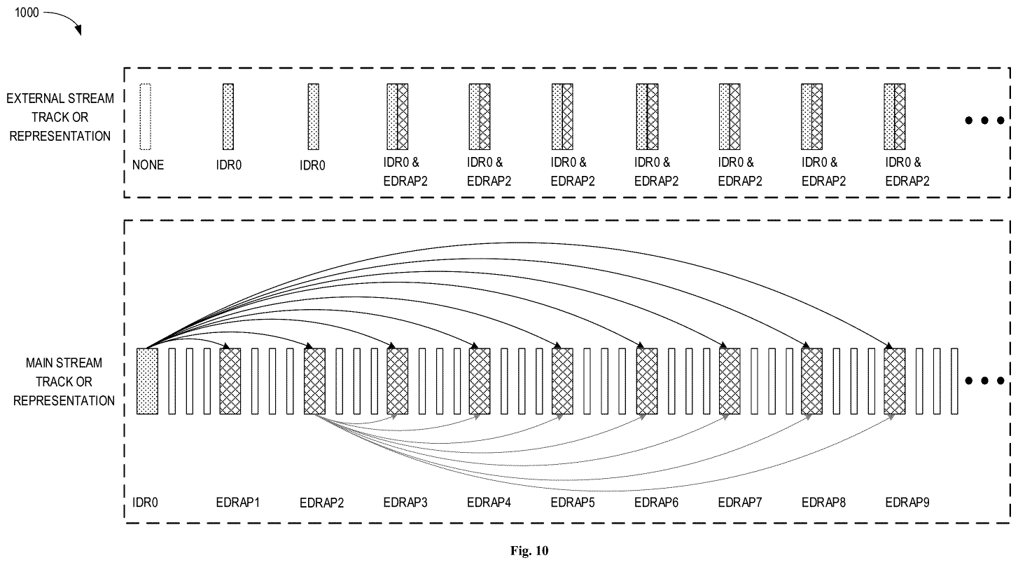

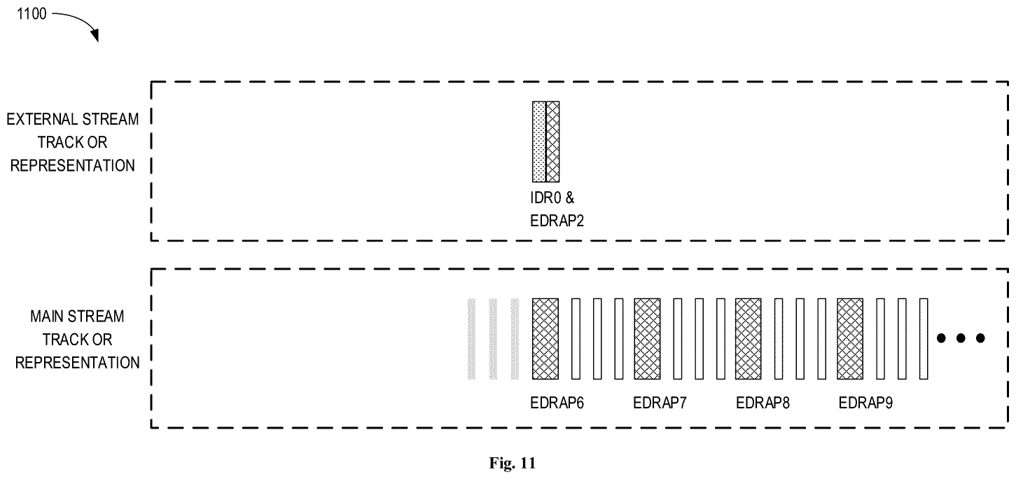

FIGS. 10 and 11 are diagrams that illustrate EDRAP based video streaming. When random accessing from or switching to the segment starting at EDRAP6, the decoder receives and decodes the segments as shown in FIG. 11.

EDRAP based video coding is supported by the EDRAP indication SEI message included in an under-development amendment to the VSEI standard, the storage part is supported by the EDRAP sample group and the associated external stream track reference included in an under-development amendment to the ISOBMFF standard, and the streaming part is supported by the main stream Representation (MSR) and external stream Representation (ESR) descriptors included an under-development amendment to the DASH standard.

### 2.4.2 the EDRAP Indication SEI Message

An amendment to the VSEI standard is being developed. The latest draft specification of this amendment includes the specification of the EDRAP indication SEI message.

The syntax and semantics of the EDRAP indication SEI message are as follows.

| | Descriptor |
|---|---|
| extended_drap_indication( payloadSize ) { | |
| edrap_rap_id_minus1 | u(16) |
| edrap_leading_pictures_decodable_flag | u(1) |
| edrap_reserved_zero_12bits | u(12) |
| edrap_num_ref_rap_pics_minus1 | u(3) |
| for( i = 0; i <= edrap_num_ref_rap_pics_minus1; i++ ) | |
| edrap_ref_rap_id[ i ] | u(16) |
| } | |

The picture associated with an extended DRAP (EDRAP) indication SEI message is referred to as an EDRAP picture.

The presence of the EDRAP indication SEI message indicates that the constraints on picture order and picture referencing specified in this subclause apply. These constraints can enable a decoder to properly decode the EDRAP picture and the pictures that are in the same layer and follow it in both decoding order and output order without needing to decode any other pictures in the same layer except the list of pictures referenceablePictures, which consists of a list of IRAP or EDRAP pictures in decoding order that are within the same CLVS and identified by the edrap_ref_rap_id[i] syntax elements.

The constraints indicated by the presence of the EDRAP indication SEI message, which shall all apply, are as follows:
The EDRAP picture is a trailing picture.
The EDRAP picture has a temporal sublayer identifier equal to 0.
The EDRAP picture does not include any pictures in the same layer in the active entries of its reference picture lists except the referenceablePictures.
Any picture that is in the same layer and follows the EDRAP picture in both decoding order and output order does not include, in the active entries of its reference picture lists, any picture that is in the same layer and precedes the EDRAP picture in decoding order or output order, with the exception of the referenceablePictures.
Any picture in the list referenceablePictures does not include, in the active entries of its reference picture lists, any picture that is in the same layer and is not a picture at an earlier position in the list referenceablePictures.
   NOTE—Consequently, the first picture in referenceablePictures, even when it is an EDRAP picture instead of an IRAP picture, does not include any picture from the same layer in the active entries of its reference picture lists.

edrap_rap_id_minus1 plus 1 specifies the RAP picture identifier, denoted as RapPicId, of the EDRAP picture.

Each IRAP or EDRAP picture is associated with a RapPicId value. The RapPicId value for an IRAP picture is inferred to be equal to 0. The RapPicId values for any two EDRAP pictures associated with the same IRAP picture shall be different.

edrap_leading_pictures_decodable_flag equal to 1 specifies that both of the following constraints apply:
Any picture that is in the same layer and follows the EDRAP picture in decoding order shall follow, in output order, any picture that is in the same layer and precedes the EDRAP picture in decoding order.
Any picture that is in the same layer and follows the EDRAP picture in decoding order and precedes the EDRAP picture in output order shall not include, in the active entries of its reference picture lists, any picture that is in the same layer and precedes the EDRAP picture in decoding order, with the exception of the referenceablePictures.

edrap_leading_pictures_decodable_flag equal to 0 does not impose such constraints.

edrap_reserved_zero_12bits shall be equal to 0 in bitstreams conforming to this version of this Specification. Other values for edrap_reserved_zero_12bits are reserved for future use by ITU-T|ISO/IEC. Decoders shall ignore the value of edrap_reserved_zero_12bits.

edrap_num_ref_rap_pics_minus1 plus 1 indicates the number of IRAP or EDRAP pictures that are within the same CLVS as the EDRAP picture and may be included in the active entries of the reference picture lists of the EDRAP picture.

edrap_ref_rap_id[i] indicates RapPicId of the i-th RAP picture that may be included in the active entries of the reference picture lists of the EDRAP picture. The i-th RAP picture shall be either the IRAP picture associated with the current EDRAP picture or an EDRAP picture associated with the same IRAP picture as the current EDRAP picture.

### 2.4.3 the EDRAP Sample Group and Associated External Stream Track Reference

An amendment to the ISOBMFF standard is being developed. The latest draft specification of this amendment includes the specifications of the EDRAP sample group and the associated external stream track reference.

The specifications of these two ISOBMFF features are as follows.

### 3.1 Definitions

external elementary stream
elementary stream containing access units with external pictures
external picture
picture that is in the external elementary stream in an EST and is needed for inter prediction reference in decoding of the elementary stream in the MST when random accessing from certain EDRAP pictures in the MST
external stream track (EST)
track containing an external elementary stream
main stream track (MST)
track containing a video elementary stream

### 3.2 Abbreviated Terms

EDRAP extended dependent random access point
EST external stream track
MST main stream track

### 8.3.3.4 Associated External Stream Track Reference

A track reference of type ‘aest’ (meaning “associated external stream track”) may be included in an MST, referencing an EST.

When an MST has a track reference of type ‘aest’, the following applies:
The MST should have at least one sample that contains an EDRAP picture.
For each sample sampleA in the MST containing an EDRAP picture, there shall be one and only one sample sampleB in the associated EST that has the same decoding time as sampleA, and a number of consecutive samples in the associated EST, starting from sampleB, shall exclusively contain all the external pictures that are needed when random accessing from the EDRAP picture contained in sampleA.

Every sample in the EST shall be identified as a sync sample. The EST track header flags shall have track_in_movie and track_in_preview both set to 0.

### 10.11 Extended DRAP (EDRAP) Sample Group

### 10.11.1 Definition

This sample group is similar to the DRAP sample group as specified in subclause 10.8; however, it enables more flexible cross-RAP referencing.

An EDRAP sample is a sample after which all samples in decoding order and in output order can be correctly decoded if the closest initial sample preceding the EDRAP sample and one or more other identified EDRAP samples earlier in decoding order than the EDRAP sample are available for reference.

The initial sample is a SAP sample of SAP type 1, 2 or 3 that is marked as such either by being a Sync sample or by the SAP sample group. For example, if the 32nd sample in a file is an initial sample consisting of an I-picture, the 48th sample may consist of a P-picture and be marked as a member of the EDRAP sample group, thereby indicating that random access can be performed at the 48th sample by first decoding the 32nd sample (ignoring samples 33-47) and then continuing to decode from the 48th sample.
NOTE: EDRAP samples can only be used in combination with SAP samples of type 1, 2 and 3. This is in order to enable the functionality of creating a decodable sequence of samples by concatenating the preceding SAP sample and zero or more other identified EDRAP samples earlier in decoding order than the EDRAP sample with the EDRAP sample and the samples following the EDRAP sample in decoding order and in output order.

A sample can be a member of the EDRAP Sample Group only if the following conditions are true:
The EDRAP sample references only the closest preceding initial sample and one or more other identified EDRAP samples earlier in decoding order than the EDRAP sample.
The EDRAP sample and all samples following the EDRAP sample in decoding order and output order can be correctly decoded when starting decoding at the EDRAP sample after having decoded the closest preceding SAP sample of type 1, 2 or 3 marked as such by being a Sync sample or by the SAP sample group and after having decoded the zero or more other identified EDRAP samples earlier in decoding order than the EDRAP sample.

### 10.11.2 Syntax

```
class VisualEdrapEntry( )
extends VisualSampleGroupEntry(‘edrp’) {
  unsigned int(3) edrap_type;
  unsigned int(3) num_ref_edrap_pics;
  unsigned int(26) reserved = 0;
  for(i=0; i<num_ref_edrap_pics; i++)
    unsigned int(16) ref_edrap_idx_delta[i];
}
```

### 10.11.3 Semantics

edrap_type is a non-negative integer. When edrap_type is in the range of 1 to 3 it indicates the SAP_type (as specified in Annex I) that the EDRAP sample would have corresponded to, had it not depended on the closest preceding SAP or other EDRAP samples. Other type values are reserved.
num_ref_edrap_pics indicates the number of other EDRAP samples that are earlier in decoding order than the EDRAP sample and are needed for reference to be able to correctly decode the EDRAP sample and all samples following the EDRAP sample in both decoding and output order when starting decoding from the EDRAP sample.
reserved shall be equal to 0. The semantics of this subclause only apply to sample group description entries with reserved equal to 0. Parsers shall allow and ignore sample group description entries with reserved greater than 0 when parsing this sample group.
ref_edrap_idx_delta[i] indicates the difference between the sample group index (i.e., the index to the list of all samples in this sample group in decoding order) of this EDRAP sample and the sample group index of the i-th RAP sample that is earlier in decoding order than the EDRAP sample and is needed for reference to be able to correctly decode the EDRAP sample and all samples following the EDRAP sample in both decoding and output order when starting decoding from this EDRAP sample. The value 1 indicates that the i-th RAP sample is the latest RAP sample in the sample group and preceding this EDRAP sample in decoding order, the value 2 indicates that the i-th RAP sample is the second latest RAP sample in the sample group and preceding this EDRAP sample in decoding order, and so on.

### 2.5 Sample Entry Type Transformation in the ISOBMFF

The ISOBMFF includes features that allow for transformation of sample entry types for protected content or those types of content that require some special post-decoder processing requirements before rendering. Examples of such post-decoder processing requirements include frame packing for stereoscopic video support and projection for omnidirectional or 360-degree video support.

In order to handle situations where the file author requires certain actions on the player or renderer, The ISOBMFF includes a mechanism that enables players to simply inspect a file to find out such requirements for rendering a bitstream and stops legacy players from decoding and rendering files that require further processing. The mechanism applies to any type of video codec.

The mechanism is similar to the content protection transformation where sample entries are hidden behind generic sample entries, ‘encv’, ‘enca’, etc., indicating encrypted or encapsulated media. The analogous mechanism for restricted video uses a transformation with the generic sample entry ‘resv’. The method may be applied when the content should only be decoded by players that present it correctly.

The restricted sample entry transformation and related signalling are specified as follows.

### 2.5.1 Restricted Sample Entry Transformation

A restricted sample entry is defined as a sample entry on which the following transformation procedure has been applied:
1) The four character code of the sample entry is replaced by the sample entry code ‘resv’ meaning restricted video.
2) A RestrictedSchemeInfoBox is added to the sample description, leaving all other boxes unmodified.
3) The original sample entry type is stored within an OriginalFormatBox contained in the RestrictedSchemeInfoBox.

A RestrictedSchemeInfoBox is formatted exactly the same as a ProtectionSchemeInfoBox, except that is uses the identifier ‘rinf’ instead of ‘sinf’ (see below).

The original sample entry type is contained in the OriginalFormatBox located in the RestrictedSchemeInfoBox (in an identical way to the ProtectionSchemeInfoBox for encrypted media).

The exact nature of the restriction is defined in the SchemeTypeBox, and the data needed for that scheme is stored in the SchemeInformationBox, again, analogously to protection information.

Restriction and protection can be applied at the same time. The order of the transformations follows from the four-character code of the sample entry. For instance, if the sample entry type is ‘resv’, undoing the above transformation may result in a sample entry type ‘encv’, indicating that the media is protected.

If the file author only wants to provide advisory information without stopping legacy players from playing the file, the RestrictedSchemeInfoBox may be placed inside the sample entry without transforming the four character code. In this case it is not necessary to include an OriginalFormatBox.

### 2.5.2 Restricted Scheme Information Box

### 2.5.2.1 Definition

Box Types: ‘rinf’
Container: Restricted Sample Entry or Sample Entry
Mandatory: Yes in Restricted Sample Entry, no otherwise
Quantity: Zero or one

The RestrictedSchemeInfoBox contains all the information required both to understand the restriction scheme applied and its parameters. It also documents the original (un-transformed) sample entry type of the media. The RestrictedSchemeInfoBox is a container Box. It is mandatory in a sample entry that uses a code indicating a restricted stream, i.e., ‘resv’.

When used in a restricted sample entry, this box shall contain the OriginalFormatBox to document the original sample entry type and a SchemeTypeBox. A SchemeInformationBox may be required depending on the restriction scheme.

### 2.5.2.2 Syntax

aligned(8) class RestrictedSchemeInfoBox(fmt) extends Box(‘rinf’) {

| OriginalFormatBox(fmt) | original_format; | |
|---|---|---|
| SchemeTypeBox | scheme_type_box; | |
| SchemeInformationBox | info; | // optional |

}

2.5.3 Scheme type box

### 2.5.3.1 Definition

Box Types: ‘schm’
Container: ProtectionSchemeInfoBox, RestrictedSchemeInfoBox, or SRTPProcessBox
Mandatory: No
Quantity: Zero or one in ‘sinf’, depending on the protection structure; Exactly one in ‘rinf’ and ‘srpp’

The SchemeTypeBox identifies the protection or restriction scheme.

### 2.5.3.2 Syntax

```
aligned(8) class SchemeTypeBox extends FullBox(‘schm’, 0, flags) {
  unsigned int(32) scheme_type; // 4CC identifying the scheme
  unsigned int(32) scheme_version; // scheme version
  if (flags & 0x000001) {
    utf8string scheme_uri; // browser uri
  }
}
```

### 2.5.3.3 Semantics

scheme_type is the code defining the protection or restriction scheme, normally expressed as a four character code;
scheme_version is the version of the scheme (used to create the content);
scheme_URI is an absolute URI allowing for the option of directing the user to a web-page if they do not have the scheme installed on their system.

### 2.5.4 Scheme Information Box

### 2.5.4.1 Definition

Box Types: ‘schi’
Container: ProtectionSchemeInfoBox, RestrictedSchemeInfoBox, or SRTPProcessBox
Mandatory: No
Quantity: Zero or one

The SchemeInformationBox is a container Box that is only interpreted by the scheme being used. Any information the encryption or restriction system needs is stored here. The content of this box is a series of boxes whose type and format are defined by the scheme declared in the SchemeTypeBox.

### 2.5.4.2 Syntax

| aligned(8) class SchemeInformationBox extends Box(‘schi’) { | |
|---|---|
| Box | scheme_specific_data[ ]; |

}

2.5.5 Original format box

### 2.5.5.1 Definition

Box Types: ‘frma’
Container: ProtectionSchemeInfoBox, RestrictedSchemeInfoBox, or CompleteTrackInfoBox
Mandatory: Yes when used in a protected sample entry, in a restricted sample entry, or in a sample entry for an incomplete track.
Quantity: Exactly one.

The OriginalFormatBox contains the four character code of the original un-transformed sample description.

### 2.5.5.2 Syntax

```
aligned(8) class OriginalFormatBox(codingname) extends Box (‘frma’) {
  unsigned int(32) data_format = codingname;
    // format of decrypted, encoded data (in case of protection)
    // or un-transformed sample entry (in case of restriction
    // and complete track information)
}
```

### 2.5.5.3 Semantics

data_format is the four character code of the original un-transformed sample entry (e.g. ‘mp4v’ if the stream contains protected or restricted MPEG-4 visual material).

### 3. Problems

There is one problem associated with the existing design for the storage part of EDRAP based video coding, storage and streaming. A sample in an external stream track (EST) may have more than one coded picture. Thus if a normal video sample entry type, e.g., a VCC sample entry type or an HEVC sample entry type, is used for an EST, the usual requirement that each sample shall contain only one coded picture would be violated.

### 4. Detailed Solutions

To solve the above problem, methods as summarized below are disclosed. The solutions should be considered as examples to explain the general concepts and should not be interpreted in a narrow way. Furthermore, these solutions can be applied individually or combined in any manner.

1) In one example, a sample entry type transformation using a new restricted scheme type, e.g., ‘aest’, to hide the normal video sample entry type. One or more of the following apply:
a. The four character code of the sample entry is the sample entry code ‘resv’.
b. The normal video sample entry type is stored within an OriginalFormatBox contained in the RestrictedSchemeInfoBox.
c. The scheme_type field in the SchemeTypeBox that is in the RestrictedSchemeInfoBox is equal to a value that indicates that a sample in the track may contain more than one coded picture.
   i. In one example, the value of the scheme_type field is equal to ‘aest’.
d. Bit 0 of the flags field of the SchemeTypeBox is equal to 0, such that the value of (flags & 0x000001) is equal to 0.
e. In one example, furthermore, a new box is specified, e.g., named EsternalStreamInfoBox, to contain information related to the EST. The new box may include one or more of the following fields:
   i. A field indicating the track ID of the main stream track (MST) associated with the EST.
   ii. A field indicating the maximum number of coded pictures in any sample in the EST.
   iii. A field indicating whether the first coded picture in each sample in the EST is an IRAP picture.
   iv. A field indicating whether each sample in the EST contains all required parameter sets for decoding of the coded pictures in the sample.
   v. A field indicating, for each sample in the EST, whether the corresponding EDRAP picture in the associated MST would satisfy the constraints when the corresponding edrap_leading_pictures_decodable_flag in the EDRAP indication SEI message is equal to 1.

### 5. Embodiments

Below are some example embodiments for some of the solution aspects summarized above in Section 4. Most relevant parts that have been added or modified are shown by using bolded words (e.g., this format indicates added text), and some of the deleted parts are shown by using words in italics between double curly brackets (e.g., {{this format indicates deleted text}}). There may be some other changes that are editorial in nature and thus not highlighted. It should be understood that only markings in this section are intended to represent changes.

### 5.1 First Embodiment

This embodiment is for item 1 and all its subitems, excluding item 1.e and all its subitems.

8.3.3.4 Associated external stream track reference

A track reference of type ‘aest’ (meaning “associated external stream track”) may be included in an MST, referencing an EST.

When an MST has a track reference of type ‘aest’, the following applies:
The MST should have at least one sample that contains an EDRAP picture.
For each sample sampleA in the MST containing an EDRAP picture, there shall be one and only one sample sampleB in the associated EST that has the same decoding time as sampleA, and a number of consecutive samples in the associated EST, starting from sampleB, shall exclusively contain all the external pictures that are needed when random accessing from the EDRAP picture contained in sampleA.

Every sample in the EST shall be identified as a sync sample. The EST track header flags shall have track_in_movie and track_in_preview both set to 0.

A restricted scheme shall be used each EST, as follows:
1) The four character code of the sample entry is the sample entry code ‘resv’.
2) The normal video sample entry type is stored within an OriginalFormatBox contained in the RestrictedSchemeInfoBox.
3) The scheme_type field in the SchemeTypeBox, which is in the RestrictedSchemeInfoBox, is equal to ‘aest’, indicating that a sample in the track may contain more than one coded picture.
4) Bit 0 of the flags field of the SchemeTypeBox is equal to 0, such that the value of (flags & 0x000001) is equal to 0.

More details of the embodiments of the present disclosure will be described below which are related to signaling of an external stream track in a media file. The embodiments of the present disclosure should be considered as examples to explain the general concepts and should not be interpreted in a narrow way. Furthermore, these embodiments can be applied individually or combined in any manner.

As used herein, the term “sample” may refer to all the data associated with a single time. The term “sample entry” may refer to a structure which defines and describes the format of some number of samples in a track. The term “track” may refer to a timed sequence of related samples. The term “box” may refer to an object-oriented building block defined by a unique type identifier and length.

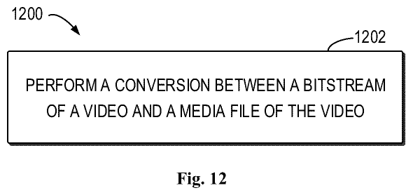

FIG. 12 illustrates a flowchart of a method 1200 for video processing in accordance with some embodiments of the present disclosure. The method 1200 may be implemented at a client or a server. The term “client” used herein may refer to a piece of computer hardware or software that accesses a service made available by a server as part of the client-server model of computer networks. By way of example, the client may be a smartphone or a tablet. The term “server” used herein may refer to a device capable of computing, in which case the client accesses the service by way of a network. The server may be a physical computing device or a virtual computing device.

As shown in FIG. 12, at 1202, a conversion between a bitstream of a video and a media file of the video is performed. A media file is a collection of data that establishes a bounded or unbounded presentation of media content in the context of a file format, e.g., the international organization for standardization (ISO) base media file format. In some embodiments, the conversion may comprise generating the media file and storing the bitstream to the media file. Additionally or alternatively, the conversion may comprise parsing the media file to reconstruct the bitstream.

In some embodiments, the media file comprises an external stream track. For example, in the context of EDRAP based video processing, the external stream track may be referenced by a corresponding main stream track. The external stream track comprises a set of samples. A sample entry type of a sample entry for the set of samples is encapsulated based on a restricted scheme. By way of example rather than limitation, a sample entry transformation using the restricted scheme may be applied to hide the sample entry type. The sample entry type may be the original sample entry type of the sample entry. It should be understood the sample entry type may be any other sample entry type, such as the current sample entry type of the sample entry. The scope of the present disclosure is not limited in this respect.

In addition, the sample entry comprises an indication associated with the restricted scheme, and a value of the indication indicates that a sample in the set of samples is allowed to contain more than one coded picture of the external stream track. By way of example rather than limitation, the sample entry may comprise a first data structure (e.g., a restricted scheme information box, also noted as RestrictedSchemeInfoBox) containing information on the restricted scheme. The first data structure may comprise a second data structure (e.g., a scheme type box, also noted as SchemeTypeBox) identifying the restricted scheme.

Moreover, the indication may comprise a first field (e.g., a scheme type field, also noted as scheme_type field) in the second data structure. In one example, a value of the first field may be equal to a predetermined code, such as ‘aest’. When a restricted scheme with the scheme type field equal to the predetermined value is in use for a track, a sample associated with the sample entry may contain more than one sample of an original track. It should be understood the predetermined code may be any other suitable code, e.g., ‘spkt’. It should also be understood that the above illustrations and/or examples are described merely for purpose of description. The scope of the present disclosure is not limited in this respect.

In view of the above, a new restricted scheme is employed to indicate that a sample in an external stream track is allowed to contain more than one coded picture. Compared with the conventional solution, the proposed method can advantageously support the EDRAP-based technology more efficiently.

In some embodiments, a uniform resource identifier (URI) of the restricted scheme may be absent from the media file. For example, the sample entry may comprise a first data structure (e.g., a restricted scheme information box) containing information on the restricted scheme, and the first data structure may comprise a second data structure (e.g., a scheme type box) identifying the restricted scheme. A value of the least significant bit (i.e., Bit 0) of a flags field in the second data structure may be equal to 0.

In some embodiments, the sample entry type may be encapsulated with a predetermined sample entry code, such as ‘resv’ or the like. Additionally, the sample entry may comprise a first data structure (e.g., a restricted scheme information box) containing information on the restricted scheme. The first data structure may comprise a third data structure (e.g., an original format box, also noted as OriginalFormatBox) storing the sample entry type.

In some additional or alternative embodiments, the media file may comprise a fourth data structure (e.g., an external stream information box, also noted as EsternalStreamInfoBox) containing information associated with the external stream track. By way of example rather than limitation, the fourth data structure may comprise at least one of the following: (1) a field indicating a track identity (ID) of a main stream track associated with the external stream track, (2) a field indicating the maximum allowable number of coded pictures in a sample in the external stream track, (3) a field indicating whether a first coded picture in each sample in the external stream track may be an intra random access point (IRAP) picture, the first coded picture may be at the first position in the respective sample, (4) a field indicating whether each sample in the external stream track contains all required parameter sets for decoding of coded pictures in the respective sample, or (5) a field indicating, for each sample in the external stream track, whether leading pictures of a corresponding EDRAP picture in a main stream track associated with the external stream track is decodable when a decoding process starts from the EDRAP picture.

In some embodiments, if the following two constraints are satisfied, leading pictures of a corresponding EDRAP picture in a main stream track associated with the external stream track is decodable when a decoding process starts from the EDRAP picture: (1) Any picture that is in the same layer and follows the EDRAP picture in decoding order shall follow, in output order, any picture that is in the same layer and precedes the EDRAP picture in decoding order; (2) Any picture that is in the same layer and follows the EDRAP picture in decoding order and precedes the EDRAP picture in output order shall not include, in the active entries of its reference picture lists, any picture that is in the same layer and precedes the EDRAP picture in decoding order, with the exception of the referenceablePictures.

According to embodiments of the present disclosure, a non-transitory computer-readable recording medium is proposed. A bitstream of a video is stored in the non-transitory computer-readable recording medium. The bitstream can be generated by a method performed by a video processing apparatus. According to the method, a conversion between the bitstream and a media file of the video is performed. The media file comprises an external stream track comprising a set of samples. A sample entry type of a sample entry for the set of samples is encapsulated based on a restricted scheme. The sample entry comprises an indication associated with the restricted scheme, and a value of the indication indicates that a sample in the set of samples is allowed to contain more than one coded picture of the external stream track.

According to embodiments of the present disclosure, a method for storing a bitstream of a video is proposed. In the method, a conversion between the bitstream and a media file of the video is performed. The media file comprises an external stream track comprising a set of samples. A sample entry type of a sample entry for the set of samples is encapsulated based on a restricted scheme. The sample entry comprises an indication associated with the restricted scheme, and a value of the indication indicates that a sample in the set of samples is allowed to contain more than one coded picture of the external stream track. Moreover, the bitstream is stored in the non-transitory computer-readable recording medium.

According to embodiments of the present disclosure, another non-transitory computer-readable recording medium is proposed. A media file of a video is stored in the non-transitory computer-readable recording medium. The bitstream can be generated by a method performed by a video processing apparatus. According to the method, a conversion between a bitstream of the video and the media file is performed. The media file comprises an external stream track comprising a set of samples. A sample entry type of a sample entry for the set of samples is encapsulated based on a restricted scheme. The sample entry comprises an indication associated with the restricted scheme, and a value of the indication indicates that a sample in the set of samples is allowed to contain more than one coded picture of the external stream track.

According to embodiments of the present disclosure, a method for storing a media file of a video is proposed. In the method, a conversion between a bitstream of the video and the media file is performed. The media file comprises an external stream track comprising a set of samples. A sample entry type of a sample entry for the set of samples is encapsulated based on a restricted scheme. The sample entry comprises an indication associated with the restricted scheme, and a value of the indication indicates that a sample in the set of samples is allowed to contain more than one coded picture of the external stream track. Moreover, the media file is stored in the non-transitory computer-readable recording medium.

Implementations of the present disclosure can be described in view of the following clauses, the features of which can be combined in any reasonable manner.

Clause 1. A method for video processing, comprising: performing a conversion between a bitstream of a video and a media file of the video, wherein the media file comprises an external stream track comprising a set of samples, a sample entry type of a sample entry for the set of samples is encapsulated based on a restricted scheme, the sample entry comprises an indication associated with the restricted scheme, and a value of the indication indicates that a sample in the set of samples is allowed to contain more than one coded picture of the external stream track.

Clause 2. The method of clause 1, wherein the sample entry type is an original sample entry type.

Clause 3. The method of any of clauses 1-2, wherein the sample entry comprises a first data structure containing information on the restricted scheme, the first data structure comprises a second data structure identifying the restricted scheme, and the indication comprises a first field in the second data structure.

Clause 4. The method of clause 3, wherein the first data structure is a restricted scheme information box, the second data structure is a scheme type box, and the first field is a scheme type field.

Clause 5. The method of any of clauses 3-4, wherein a value of the first field is equal to a predetermined code.

Clause 6. The method of any of clauses 1-5, wherein a uniform resource identifier (URI) of the restricted scheme is absent from the media file.

Clause 7. The method of any of clauses 1-6, wherein the sample entry comprises a first data structure containing information on the restricted scheme, the first data structure comprises a second data structure identifying the restricted scheme, and a value of the least significant bit of a flags field in the second data structure is equal to 0.

Clause 8. The method of clause 7, wherein the first data structure is a restricted scheme information box, and the second data structure is a scheme type box.

Clause 9. The method of any of clauses 1-8, wherein the sample entry type is encapsulated with a predetermined sample entry code.

Clause 10. The method of any of clauses 1-9, wherein the sample entry comprises a first data structure containing information on the restricted scheme, and the first data structure comprises a third data structure storing the sample entry type.

Clause 11. The method of clause 10, wherein the first data structure is a restricted scheme information box, and the third data structure is an original format box.

Clause 12. The method of any of clauses 1-11, wherein the media file comprises a fourth data structure containing information associated with the external stream track.

Clause 13. The method of clause 12, wherein the fourth data structure comprises at least one of the following: a field indicating a track identity (ID) of a main stream track associated with the external stream track, a field indicating the maximum allowable number of coded pictures in a sample in the external stream track, a field indicating whether a first coded picture in each sample in the external stream track is an intra random access point (IRAP) picture, the first coded picture being at the first position in the respective sample, a field indicating whether each sample in the external stream track contains all required parameter sets for decoding of coded pictures in the respective sample, or a field indicating, for each sample in the external stream track, whether leading pictures of a corresponding extended dependent random access point (EDRAP) picture in a main stream track associated with the external stream track are decodable when a decoding process starts from the EDRAP picture.

Clause 14. The method of any of clauses 1-13, wherein the fourth data structure is an external stream information box.

Clause 15. The method of any of clauses 1-14, wherein the media file is of an international organization for standardization (ISO) base media file format.

Clause 16. The method of any of clauses 1-15, wherein the conversion comprises generating the media file and storing the bitstream to the media file.

Clause 17. The method of any of clauses 1-15, wherein the conversion comprises parsing the media file to reconstruct the bitstream.

Clause 18. An apparatus for processing video data comprising a processor and a non-transitory memory with instructions thereon, wherein the instructions upon execution by the processor, cause the processor to perform a method in accordance with any of clauses 1-17.

Clause 19. A non-transitory computer-readable storage medium storing instructions that cause a processor to perform a method in accordance with any of clauses 1-17.

Clause 20. A non-transitory computer-readable recording medium storing a bitstream of a video which is generated by a method performed by a video processing apparatus, wherein the method comprises: performing a conversion between the bitstream and a media file of the video, wherein the media file comprises an external stream track comprising a set of samples, a sample entry type of a sample entry for the set of samples is encapsulated based on a restricted scheme, the sample entry comprises an indication associated with the restricted scheme, and a value of the indication indicates that a sample in the set of samples is allowed to contain more than one coded picture of the external stream track.

Clause 21. A method for storing a bitstream of a video, comprising: performing a conversion between the bitstream and a media file of the video; and storing the bitstream in a non-transitory computer-readable recording medium, wherein the media file comprises an external stream track comprising a set of samples, a sample entry type of a sample entry for the set of samples is encapsulated based on a restricted scheme, the sample entry comprises an indication associated with the restricted scheme, and a value of the indication indicates that a sample in the set of samples is allowed to contain more than one coded picture of the external stream track.

Clause 22. A non-transitory computer-readable recording medium storing a media file of a video which is generated by a method performed by a video processing apparatus, wherein the method comprises: performing a conversion between a bitstream of the video and the media file, wherein the media file comprises an external stream track comprising a set of samples, a sample entry type of a sample entry for the set of samples is encapsulated based on a restricted scheme, the sample entry comprises an indication associated with the restricted scheme, and a value of the indication indicates that a sample in the set of samples is allowed to contain more than one coded picture of the external stream track.

Clause 23. A method for storing a media file of a video, comprising: performing a conversion between a bitstream of the video and the media file; and storing the media file in a non-transitory computer-readable recording medium, wherein the media file comprises an external stream track comprising a set of samples, a sample entry type of a sample entry for the set of samples is encapsulated based on a restricted scheme, the sample entry comprises an indication associated with the restricted scheme, and a value of the indication indicates that a sample in the set of samples is allowed to contain more than one coded picture of the external stream track.

### Example Device

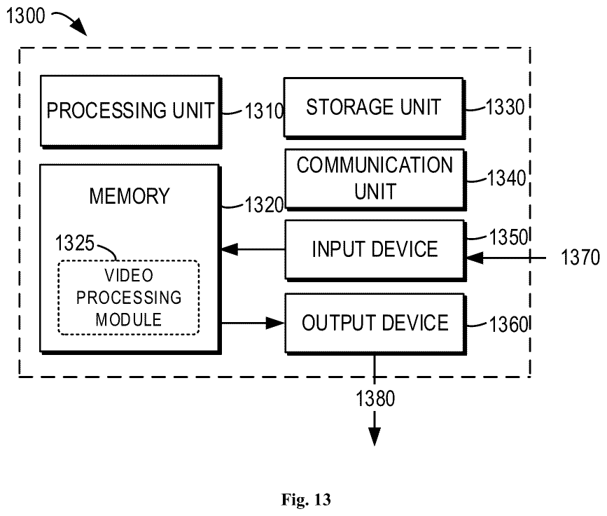

FIG. 13 illustrates a block diagram of a computing device 1300 in which various embodiments of the present disclosure can be implemented. The computing device 1300 may be implemented as or included in the source device 110 (or the video encoder 114 or 200) or the destination device 120 (or the video decoder 124 or 300).

It would be appreciated that the computing device 1300 shown in FIG. 13 is merely for purpose of illustration, without suggesting any limitation to the functions and scopes of the embodiments of the present disclosure in any manner.

As shown in FIG. 13, the computing device 1300 includes a general-purpose computing device 1300. The computing device 1300 may at least comprise one or more processors or processing units 1310, a memory 1320, a storage unit 1330, one or more communication units 1340, one or more input devices 1350, and one or more output devices 1360.

In some embodiments, the computing device 1300 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1300 can support any type of interface to a user (such as “wearable” circuitry and the like).

The processing unit 1310 may be a physical or virtual processor and can implement various processes based on programs stored in the memory 1320. In a multi-processor system, multiple processing units execute computer executable instructions in parallel so as to improve the parallel processing capability of the computing device 1300. The processing unit 1310 may also be referred to as a central processing unit (CPU), a microprocessor, a controller or a microcontroller.

The computing device 1300 typically includes various computer storage medium. Such medium can be any medium accessible by the computing device 1300, including, but not limited to, volatile and non-volatile medium, or detachable and non-detachable medium. The memory 1320 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1330 may be any detachable or non-detachable medium and may include a machine-readable medium such as a memory, flash memory drive, magnetic disk or another other media, which can be used for storing information and/or data and can be accessed in the computing device 1300.

The computing device 1300 may further include additional detachable/non-detachable, volatile/non-volatile memory medium. Although not shown in FIG. 13, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1340 communicates with a further computing device via the communication medium. In addition, the functions of the components in the computing device 1300 can be implemented by a single computing cluster or multiple computing machines that can communicate via communication connections. Therefore, the computing device 1300 can operate in a networked environment using a logical connection with one or more other servers, networked personal computers (PCs) or further general network nodes.

The input device 1350 may be one or more of a variety of input devices, such as a mouse, keyboard, tracking ball, voice-input device, and the like. The output device 1360 may be one or more of a variety of output devices, such as a display, loudspeaker, printer, and the like. By means of the communication unit 1340, the computing device 1300 can further communicate with one or more external devices (not shown) such as the storage devices and display device, with one or more devices enabling the user to interact with the computing device 1300, or any devices (such as a network card, a modem and the like) enabling the computing device 1300 to communicate with one or more other computing devices, if required. Such communication can be performed via input/output (I/O) interfaces (not shown).

In some embodiments, instead of being integrated in a single device, some or all components of the computing device 1300 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1300 may be used to implement video encoding/decoding in embodiments of the present disclosure. The memory 1320 may include one or more video processing modules 1325 having one or more program instructions. These modules are accessible and executable by the processing unit 1310 to perform the functionalities of the various embodiments described herein.

In the example embodiments of performing video encoding, the input device 1350 may receive video data as an input 1370 to be encoded. The video data may be processed, for example, by the video processing module 1325, to generate an encoded bitstream. The encoded bitstream may be provided via the output device 1360 as an output 1380.

In the example embodiments of performing video decoding, the input device 1350 may receive an encoded bitstream as the input 1370. The encoded bitstream may be processed, for example, by the video processing module 1325, to generate decoded video data. The decoded video data may be provided via the output device 1360 as the output 1380.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
performing a conversion between a bitstream of a video and a media file of the video,
wherein the media file comprises an external stream track comprising a set of samples, a sample entry type of a sample entry for the set of samples is encapsulated based on a restricted scheme, the sample entry comprises an indication associated with the restricted scheme, and a value of the indication indicates that a sample in the set of samples is allowed to contain more than one coded picture of the external stream track.

2. The method of claim 1, wherein the sample entry type is an original sample entry type.

3. The method of claim 1, wherein the sample entry comprises a first data structure containing information on the restricted scheme, the first data structure comprises a second data structure identifying the restricted scheme, and the indication comprises a first field in the second data structure.

4. The method of claim 3, wherein the first data structure is a restricted scheme information box, the second data structure is a scheme type box, and the first field is a scheme type field.

5. The method of claim 3, wherein a value of the first field is equal to a predetermined code.

6. The method of claim 1, wherein a uniform resource identifier (URI) of the restricted scheme is absent from the media file.

7. The method of claim 1, wherein the sample entry comprises a first data structure containing information on the restricted scheme, the first data structure comprises a second data structure identifying the restricted scheme, and a value of the least significant bit of a flags field in the second data structure is equal to 0.

8. The method of claim 7, wherein the first data structure is a restricted scheme information box, and the second data structure is a scheme type box.

9. The method of claim 1, wherein the sample entry type is encapsulated with a predetermined sample entry code.

10. The method of claim 1, wherein the sample entry comprises a first data structure containing information on the restricted scheme, and the first data structure comprises a third data structure storing the sample entry type.

11. The method of claim 1, wherein the media file comprises a fourth data structure containing information associated with the external stream track.

12. The method of claim 1, wherein the media file is of an international organization for standardization (ISO) base media file format.

13. The method of claim 1, wherein the conversion comprises generating the media file and storing the bitstream to the media file.

14. The method of claim 1, wherein the conversion comprises parsing the media file to reconstruct the bitstream.

15. An apparatus for processing video data comprising a processor and a non-transitory memory with instructions thereon, wherein the instructions upon execution by the processor, cause the processor to perform acts comprising:
performing a conversion between a bitstream of a video and a media file of the video,
wherein the media file comprises an external stream track comprising a set of samples, a sample entry type of a sample entry for the set of samples is encapsulated based on a restricted scheme, the sample entry comprises an indication associated with the restricted scheme, and a value of the indication indicates that a sample in the set of samples is allowed to contain more than one coded picture of the external stream track.

16. The method of claim 15, wherein the sample entry type is an original sample entry type, or
wherein the sample entry comprises a first data structure containing information on the restricted scheme, the first data structure comprises a second data structure identifying the restricted scheme, and the indication comprises a first field in the second data structure, or
wherein a uniform resource identifier (URI) of the restricted scheme is absent from the media file, or
wherein the sample entry comprises a first data structure containing information on the restricted scheme, the first data structure comprises a second data structure identifying the restricted scheme, and a value of the least significant bit of a flags field in the second data structure is equal to 0.

17. A non-transitory computer-readable storage medium storing instructions that cause a processor to perform acts comprising:
performing a conversion between a bitstream of a video and a media file of the video,
wherein the media file comprises an external stream track comprising a set of samples, a sample entry type of a sample entry for the set of samples is encapsulated based on a restricted scheme, the sample entry comprises an indication associated with the restricted scheme, and a value of the indication indicates that a sample in the set of samples is allowed to contain more than one coded picture of the external stream track.

18. The non-transitory computer-readable storage medium of claim 17, wherein the sample entry type is an original sample entry type, or
wherein the sample entry comprises a first data structure containing information on the restricted scheme, the first data structure comprises a second data structure identifying the restricted scheme, and the indication comprises a first field in the second data structure, or
wherein a uniform resource identifier (URI) of the restricted scheme is absent from the media file, or
wherein the sample entry comprises a first data structure containing information on the restricted scheme, the first data structure comprises a second data structure identifying the restricted scheme, and a value of the least significant bit of a flags field in the second data structure is equal to 0.

19. A non-transitory computer-readable recording medium storing a media file of a video which is generated by a method performed by a video processing apparatus, wherein the method comprises:
performing a conversion between a bitstream of the video and the media file,
wherein the media file comprises an external stream track comprising a set of samples, a sample entry type of a sample entry for the set of samples is encapsulated based on a restricted scheme, the sample entry comprises an indication associated with the restricted scheme, and a value of the indication indicates that a sample in the set of samples is allowed to contain more than one coded picture of the external stream track.

20. The non-transitory computer-readable recording medium of claim 19, wherein the sample entry type is an original sample entry type, or
wherein the sample entry comprises a first data structure containing information on the restricted scheme, the first data structure comprises a second data structure identifying the restricted scheme, and the indication comprises a first field in the second data structure, or
wherein a uniform resource identifier (URI) of the restricted scheme is absent from the media file, or
wherein the sample entry comprises a first data structure containing information on the restricted scheme, the first data structure comprises a second data structure identifying the restricted scheme, and a value of the least significant bit of a flags field in the second data structure is equal to 0.
